(19) United States
(12) Patent Application Publication
(10) Pub. No.: US 2016/0370296 A1
(43) Pub. Date: Dec. 22, 2016

(54) 3D tessellation imaging

(71) Applicants: Michael Mermelstein, Cambridge, MA (US); Charles Cameron Abnet, Waltham, MA (US)

(72) Inventors: Michael Mermelstein, Cambridge, MA (US); Charles Cameron Abnet, Waltham, MA (US)

(21) Appl. No.: 15/185,301

(22) Filed: Jun. 17, 2016

Related U.S. Application Data
(60) Provisional application No. 62/182,096, filed on Jun. 19, 2015.

(51) Int. Cl. G01N 21/64; G02B 21/00

(52) U.S. Cl. CPC G01N 21/6458; G02B 21/0032; G02B 21/0028; G02B 21/0076; G01N 2021/6471

(57) ABSTRACT

The invention provides a new system and method for imaging a specimen. The system projects a three-dimensional crystalline pattern of light, a tessellation, and records the specimen's emitted light at locations where a portion of the specimen coincides with the pattern.

### CROSS-REFERENCE TO RELATED APPLICATIONS

This application claims the benefit of provisional patent application No. 62/182,096, filed Jun. 19, 2015.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### SEQUENCE LISTING OR PROGRAM

Not applicable

### STATEMENT REGARDING PRIOR DISCLOSURES BY THE INVENTOR OR A JOINT INVENTOR

Not applicable

### BACKGROUND OF THE INVENTION

Field of Invention

The invention relates to the projection of a pattern of radiation and particularly to a system and method using a projected radiation pattern to improve fluorescence imaging.

Summary of Prior Art

Biology is intricately organized at the nanoscale, yet its functional elements, such as the neuronal networks in the brain, often span over distances of centimeters. This poses a formidable challenge to mapping neuronal interconnections in brain tissue volumes.

Although light microscopy is a well-established and powerful modality for investigating biological systems, it is as yet not ideal as a high-resolution volume mapping solution. Historically, the limit on resolution has been set by diffraction, while the limit on volume size has been set by the scattering and absorbing nature of biological tissue. Recently, science has reduced these limitations. A growing variety of super-resolution methods have surpassed the diffraction limit, while tissue clearing techniques such as CLARITY have bypassed most of the scattering and absorption issues by rendering tissues transparent. And yet, great difficulties remain. Super-resolution techniques remain slow, or are often limited by optical or mechanical complexity, or are not compatible with large three-dimensional samples, or are not compatible with a wide range of wavelengths, or have limited fields of view, or have anisotropic resolution in three dimensions.

The highest resolution prior-art microscopes with an effectively arbitrary color-palette in fluorescence employ Structured Illumination Microscopy (SIM). SIM is a category of microscopy methods that subdivides the point spread function (PSF) of an objective lens into a portion that is illuminated and a portion that is relatively dark. In fluorescence contrast, for example, the effective PSF under this illumination includes the bright portion and, to a degree, not the dark portion of the objective's PSF. Thus the effective PSF is smaller than the objective's PSF with structured illumination, and the objective lens can resolve fluorescent structures more closely spaced with SIM. Therefore, these methods provide a superresolution imaging capability. In low light, as in fluorescence imaging of tissue volumes, SIM can be slow, however.

Confocal Microscopy (CM) can be regarded as a class of SIM methods. The structured illumination in this case comprises an isolated point or isolated points of light projected into the specimen volume. Since the points are serially scanned throughout the volume, and since each scan position requires a certain, finite exposure time, CM requires a relatively long time to capture an image. For example, if the total illuminated area is 1% of the focal plane, 100× more exposure time will be required than if the whole field of view is illuminated uniformly with that same peak intensity. CM further incorporates a confocal spatial filter that passes only a fraction of the light from the specimen. The result is a yet longer required exposure time.

Another class of SIM methods, called SR-SIM, illuminates a greater portion of the field of view—for example 50% in a pattern of finely-spaced stripes. These methods require many camera frames for image synthesis. Each frame is illuminated by a different pattern—for example shifted and rotated transformations of the first pattern. Generally, since time is required to shift and rotate these SIM patterns, and since many frames are needed, acquiring these SIM images in practice can be slow. Furthermore, in this case, a complex calculation joins information from these camera frames. Unfortunately, this calculation is susceptible to contributing undesirable artifacts to the computed image.

For applications like brain tissue imaging, a higher imaging speed, with a freedom from artifacts, and with isotropic resolution is desirable.

### SUMMARY OF THE INVENTION

The present invention seeks to improve on prior art structured illumination microscopy for high-speed volume scanning of transparent tissue specimens by (1) removing the time-consuming step of transforming SIM patterns between frames, (2) providing a simple image interpretation with a reduced likelihood of undesirable image artifacts, and (3) providing isotropic resolution in transparent specimen volumes. The new method, 3D Tessellation Imaging (3DTI), comprises an interference-pattern structured illumination microscope with a number of illumination beams. The hallmarks of 3DTI include the nature of the projected pattern and the interpretation of imagery sensed during specimen translation through this pattern. Specifically, a region of the specimen volume is filled with a sparse, regular pattern of brightly-peaked kernels that form a tessellation of three-space. Those bright peaks are surrounded by a buffer of relative darkness. The 3D pattern divides a collection PSF overlaid in the same space. A substantially transparent specimen is translated through the field of bright peaks and a conventional fluorescence imaging setup collects the fluorescence arising from the illuminated portions of the specimen. The specimen's translation scans specimen regions of interest through the illumination peaks. Because the illumination pattern is effectively stationary, no time is needed to transform SIM patterns between frames as in prior art methods.

Thus 3DTI inherits the desirable properties of SR-SIM as well as CM. Notably, it is compatible with the same florescent molecules, color channels, and color multiplexing approaches as those two methods. Its field of view is, in its preferred embodiment, illuminated with points of light, as in CM, leading to a relatively straightforward raw image interpretation with a low likelihood of undesirable image artifacts. But at the same time, as in SR-SIM, its illumination pattern illuminates much more than 1% of the field of view typical of CM, resulting in faster imaging compared with CM. Moreover, unlike SR-SIM and CM, the pattern is stationary from frame to frame, and the specimen is scanned through the stationary star-field. Finally, in its preferred embodiment, the 3DTI illumination pattern comprises isolated peaks of light that are each substantially equally compact in three dimensions, providing substantially isotropic 3D resolution.

### BRIEF DESCRIPTION OF THE DRAWINGS

FIG. 1 shows a schematic diagram of an embodiment of a 3D Tessellation Imager.

FIG. 2 shows a schematic diagram of an embodiment of a 3D Tessellation Imager including additional provisions to modify beam parameters e.g. a beam's phase relative to other beams.

FIG. 3 shows the tetrahedron beam configuration, not to scale.

FIG. 4 shows the cube beam configuration, not to scale.

FIG. 5 plots the k-vector and linear polarization for 3DTI using tetrahedron geometry.

FIG. 6 plots the k-vector and linear polarization for 3DTI using cube geometry.

FIG. 7 shows (a) The simulated illumination pattern arising from the tetrahedron beam geometry of FIG. 5. (b) The point spread function of an objective lens at the fluorescence wavelength. (c) The product of the two, the spatial sensitivity of a camera pixel to fluorescence in the specimen.

FIG. 8 shows 3DTI with two opposing objective lenses. These lenses project a tetrahedral illumination pattern and image the resulting specimen fluorescence, each objective to its own camera.

FIG. 9 shows illumination beams emerging from one objective or outside the objective aperture.

FIG. 10 shows illumination beams emerging from two objectives or outside the objective apertures.

FIG. 11 is an illustration of the process of estimating a specimen's brightness from collected raw data.

### DETAILED DESCRIPTION OF THE INVENTION

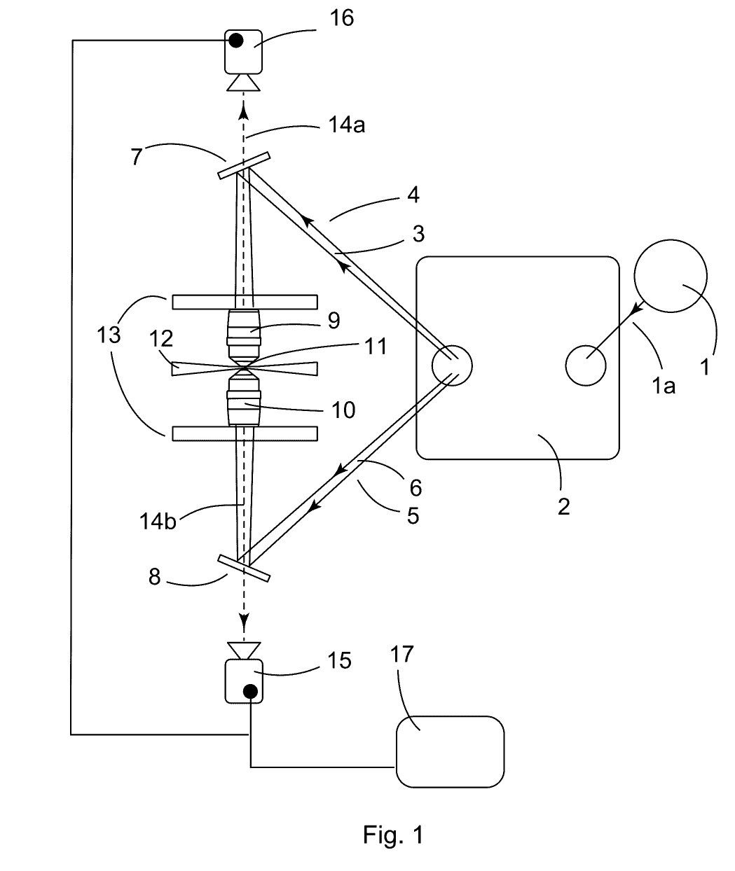

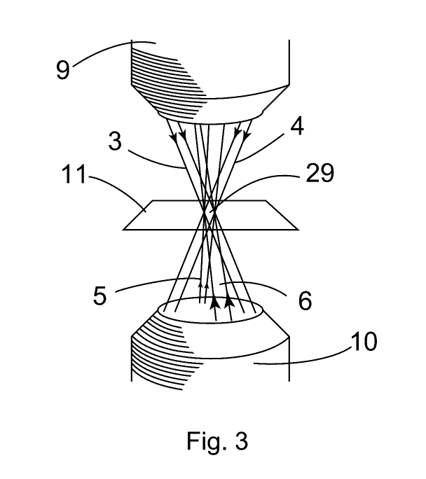

A schematic representation of a 3D Tessellation Imaging (3DTI) setup is shown in FIG. 1. In a preferred embodiment, a single coherent input beam 1a from a light source 1 is split into several output beams 3, 4, 5, and 6 by beam conditioning optics 2. For example, the beam conditioning optics can be an assembly of beamsplitters, mirrors, and lenses that control the phase, beam direction, and beam focus in a manner well known to the art. In this embodiment, these output beams are then directed through an optical system comprised of steering mirrors 7 and 8 which aim the output beams into the rear aperture of two objective lenses 9 and 10 suitably mounted on a rigid and stable platform 13. The objective lenses recombine the beams in a predetermined region of overlap (see FIG. 3 for example) where a specimen 11 is positioned on a translating stage 12. The overlapping beams form a crystalline interference pattern (a 3D tessellation) used to illuminate selected portions of the specimen. The beams enter the region of overlap with a predetermined set of angles, intensities, phases, and polarizations. The set of these parameters is referred to here as a beam geometry.

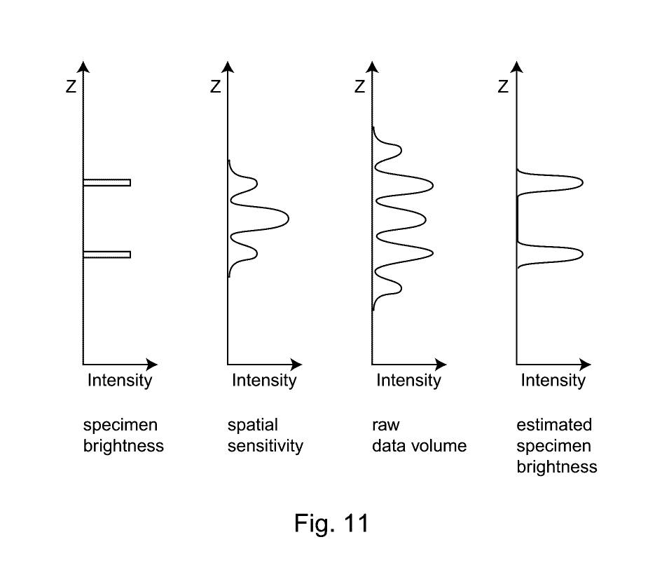

The specimen is translated within the interference pattern and will fluoresce where areas of fluorescently labeled (or inherently fluorescent) structures coincide with bright regions of the 3D tessellation pattern. One or more objective lenses are used to form images of the fluorescence as the specimen is moved through the pattern. The emitted fluorescence is represented by the dotted vectors 14a and 14b. Appropriate fluorescence filters and other fluorescence imaging apparatus known to the art (not shown) direct the images to one or more digital cameras. In this embodiment, two cameras are used, 15 and 16. The cameras collect a volume of raw image frames corresponding with known positions of the specimen over time. The cameras are connected to a storage and computation system 17. For example, this system can be a remote server computer with memory. Image synthesis and processing are carried out by the storage and computation system. An image synthesis calculation merges these raw image frames to form a final volume image. This calculation appends measured fluorescent brightness values corresponding to illuminated and imaged points within the specimen to spatially corresponding voxels in a first volume image. This first volume image can be further processed, for example by a deconvolution or similar calculation, to form a second, final volume image as depicted in FIG. 11.

In the preferred embodiment, the design of the beam geometry provides a crystalline pattern of illumination points arising from the coherent interference of the illumination beams. The mapping of this design goal to beam angles, phases, and polarizations is not obvious, and solutions consistent with the present invention are quite rare in the available parameter space. Illumination points with substantially isotropic compactness in three dimensions are desirable. Point spacing in Z (along the objective's optical axis) may need to be more sparse than X and Y spacing, for example, to account for the collection PSF's extent in Z compared with X and Y. Beam geometries that can be directed cleanly from within or from outside of objective lens apertures and other physical constraints are the most useful.

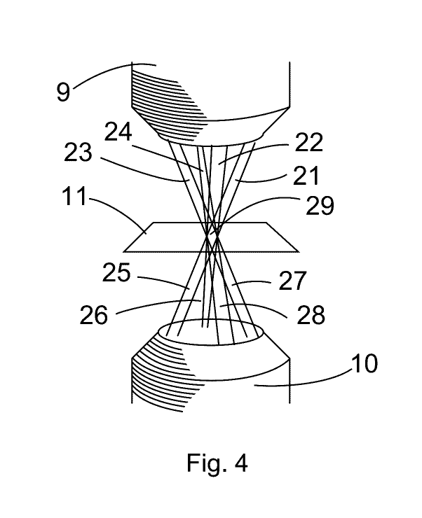

The schematic in FIG. 1 is based on a beam geometry with four illumination beams grouped into two beam pairs, 3, 4, and 5, 6. Each pair emerges from one of two objectives, 9 and 10, as illustrated in FIG. 3. A more complex arrangement of eight beams is shown in FIG. 4, where beams 21, 22, 23, 24, 25, 26, 27, and 28 are directed to a region of overlap 29 coincident with a portion of specimen 11.

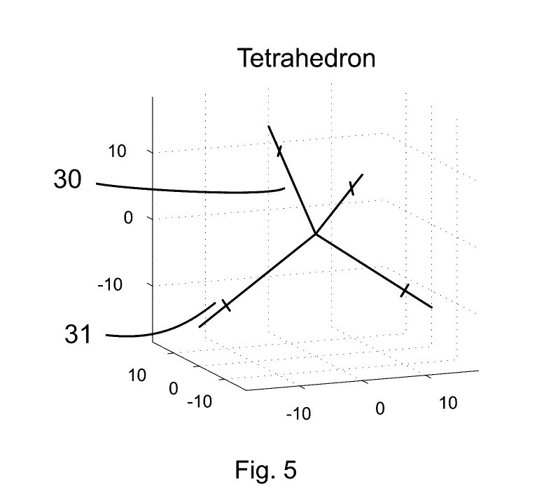

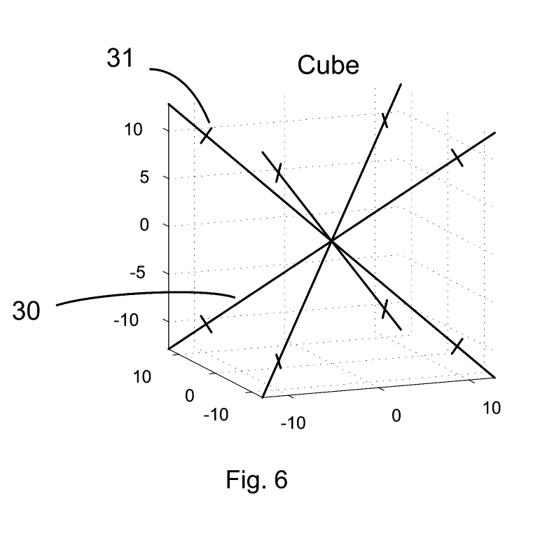

Drawn to scale, the corresponding beam geometries for four beams and eight beams are illustrated in FIGS. 5 and 6 respectively. A set of laser beams travel along the vectors (solid lines) 30 toward a central volume of overlap where they form a 3D crystalline interference pattern. These vectors are k-vectors for 488 nm (in air) light, in water, plotted in radians of the electromagnetic wave's phase per micron. The short crossing lines 31 indicate linear polarization vectors. The direction (\vec{k}) and linear polarization (\hat{p}) vectors of these two beam geometries are tabulated below.

### Beam Geometry 1: “Tetrahedron”

| \vec{k}ₓ | \vec{k}_{y} | \vec{k}_{z} | \hat{p}ₓ | \hat{p}_{y} | \hat{p}_{z} | Source |
|---|---|---|---|---|---|---|
| 0 | 13.9819 | 9.8867 | 0.8660 | 0.2887 | −0.4082 | Objec- |
| | | | | | | tive 1 |
| 0 | −13.9819 | 9.8867 | 0.8660 | 0.2887 | 0.4082 | Objec- |
| | | | | | | tive 1 |
| 13.9819 | 0 | −9.8867 | 0.2887 | 0.8660 | 0.4082 | Objec- |
| | | | | | | tive 2 |
| −13.9819 | 0 | −9.8867 | 0.2887 | 0.8660 | −0.4082 | Objec- |
| | | | | | | tive 2 |

### Beam Geometry 2: “Cube”

| \vec{k}ₓ | \vec{k}_{y} | \vec{k}_{z} | \hat{p}ₓ | \hat{p}_{y} | \hat{p}_{z} | Source |
|---|---|---|---|---|---|---|
| 0 | 13.9819 | 9.8867 | 0.8660 | 0.2887 | −0.4082 | Objec- |
| | | | | | | tive 1 |
| 0 | −13.9819 | 9.8867 | 0.8660 | 0.2887 | 0.4082 | Objec- |
| | | | | | | tive 1 |
| 13.9819 | 0 | 9.8867 | 0.2887 | 0.8660 | −0.4082 | Objec- |
| | | | | | | tive 1 |
| −13.9819 | 0 | 9.8867 | 0.2887 | 0.8660 | 0.4082 | Objec- |
| | | | | | | tive 1 |
| 0 | 13.9819 | −9.8867 | 0.8660 | 0.2887 | 0.4082 | Objec- |
| | | | | | | tive 2 |
| 0 | −13.9819 | −9.8867 | 0.8660 | 0.2887 | −0.4082 | Objec- |
| | | | | | | tive 2 |
| 13.9819 | 0 | −9.8867 | 0.2887 | 0.8660 | 0.4082 | Objec- |
| | | | | | | tive 2 |
| −13.9819 | 0 | −9.8867 | 0.2887 | 0.8660 | −0.4082 | Objec- |
| | | | | | | tive 2 |

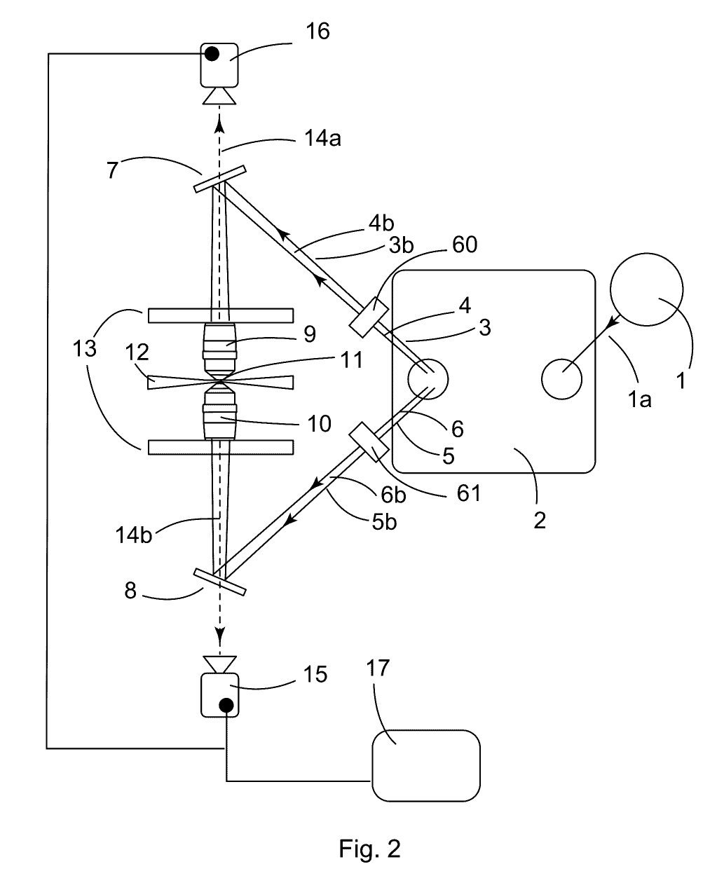

These tables assume equal amplitude of the beams and equal path-lengths (or equal phase) of the beams at some point in the specimen. In an alternative embodiment, the beam frequencies are relatively shifted, for example by Doppler shifts arising from acousto-optic modulation, leading to a rolling phase relationship between beams and a dynamic structured illumination pattern. In this alternative embodiment, the resulting locations of illumination points change over a fast timescale. A schematic setup with additional control of beam parameters using modulators 60 and 61 is shown in FIG. 2. In this example, the resulting modulated beams are 3b, 4b, 5b, and 6b. Thus, instead of translating the specimen through a stationary pattern, the pattern could translate past the specimen with the aid of a beam modulator. Furthermore, other pattern changes can be used, such as a scan of the pattern's scale, producing a chirp of the pattern's spatial frequency over time. Such a scan is possible, for example, by elongating in Z and retracting in X and Y the tetrahedron beam geometry over time.

The two beam geometries, tabulated above, are named for the polyhedra whose vertices coincide with the ends of the k-vectors. The two configurations, when oriented as shown in FIGS. 5 and 6, can be divided into an upper group and a lower group of beams aiming toward the center. Each group fits within a cone described by an internal full angle of 109.47°. That cone corresponds to a Numerical Aperture (NA) of 1.086 in water. Therefore, a regular cube and a regular tetrahedral configuration of beams is (just) possible from a pair of opposing objectives with a 1.10 NA in water. Beams projected from lower-NA objectives introduce a variation from polyhedral regularity, but such beam geometries can still provide useful illumination patterns.

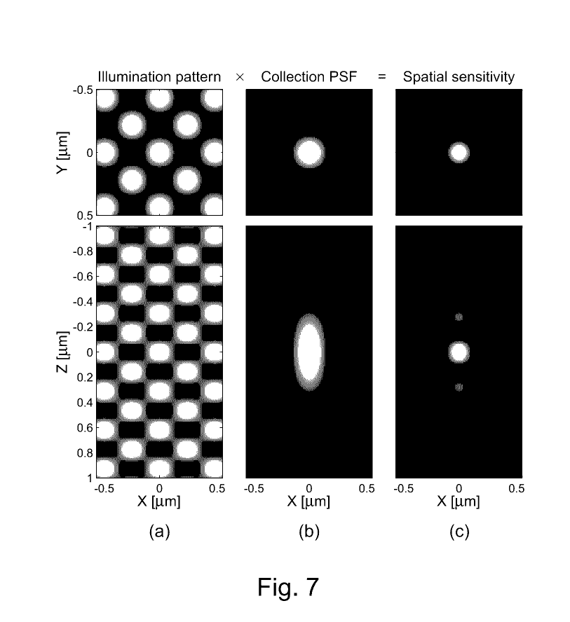

FIG. 7a shows the interference pattern that arises where the four beams of FIG. 5 overlap (white is higher intensity and black is lower intensity). The pattern is characterized by balls of light stacked in a crystalline pattern.

These balls of light are tiny, and about three of them fit in the collection PSF shown in FIG. 7b. Consider a point on an image sensor at the focus of that collection PSF. It will sense light fluoresced within the PSF volume. However, fluorescence will only occur where there is illumination light to excite it. So the overall sensitivity of that point on the image sensor will be the product of the illumination pattern (in FIG. 7a) with the collection PSF (in FIG. 7b). This product is the effective PSF for the corresponding pixel, shown in FIG. 7c.

The spatial dimensions of these patterns are influenced by the beam geometry, the laser wavelength, the immersion medium, and the objective lens NA. This simulation is for a 488 nm (in air) laser wavelength in water immersion, with 511 nm fluorescence emission collected by a 1.27 NA objective lens.

A substantially transparent specimen 11 is held in the space where the beams overlap. In the case of a gel or other floppy specimen, it may be adhered to a coverslip or sandwiched between two coverslips held in a frame. Volume scanning is achieved by moving the specimen through the illuminated region, for example, through Z for each XY location of interest.

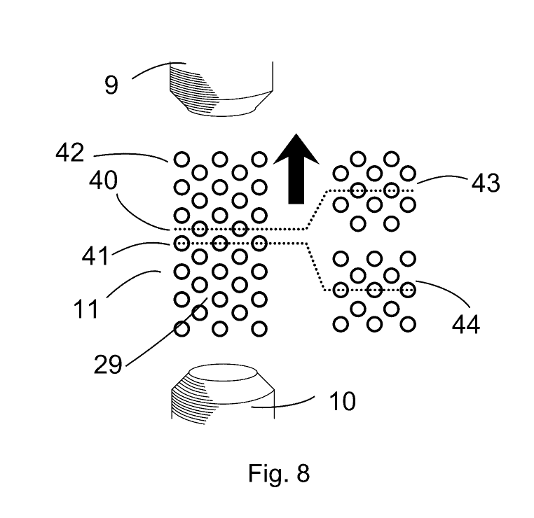

In one embodiment, the interaction of the specimen with the illumination pattern is recorded with multiple focal planes, as shown in FIG. 8. In this Figure, a cross-section of the illumination pattern is illustrated as a pattern of circles 42 where each circle represents a region of high brightness. Each objective lens, 9 and 10, projects an image to a camera (not shown). By providing a half-period offset in Z between their focal planes 40 and 41 (indicated by the dotted lines through the X-Z illustration on the left) each camera is sensitive to specimen fluorescence along a vertical column where the other view is dark (shown in the two X-Y illustrations 43 and 44 on the right). With the specimen continuously translating through Z (indicated by the bold arrow), the two cameras record all the information needed to form a 3D image at twice the XY pitch of projected pattern.

The volume of raw image frames from the camera(s) will capture the convolutions of the specimen brightness with sensitivity patterns like the one shown in FIG. 7c. In a typical deconvolution problem, each pixel is assumed to have the same convolution kernel (a point spread function). Here however, each pixel will have its own convolution kernel, depending on its alignment with the illumination pattern.

Recovering the specimen brightness from these convolutions is the work of a deconvolution algorithm. The raw images will contain various artifacts, including “ghost images” of the specimen, copied by the Z side-lobes (apparent in FIG. 7c) of the pixel sensitivity patterns. So a deconvolution algorithm ideally would recover the desired brightness pattern of the sample, minimizing ghost images and other artifacts. A numerical deconvolution (linear, nonlinear, iterative, or a combination of these) can be computed as a post-processing step, operating on a first data volume of raw camera frames and resulting in a second data volume of estimated specimen brightness. The illustration of FIG. 11 depicts a deconvolution process known to the art. In this case, a specimen with a simple brightness variation along the Z axis is sampled by an imaging system with a known spatial sensitivity. The collected raw data has “ghost” images represented by additional brightness artifacts along Z. To estimate the original specimen brightness, the collected raw data is deconvolved using the known sensitivity.

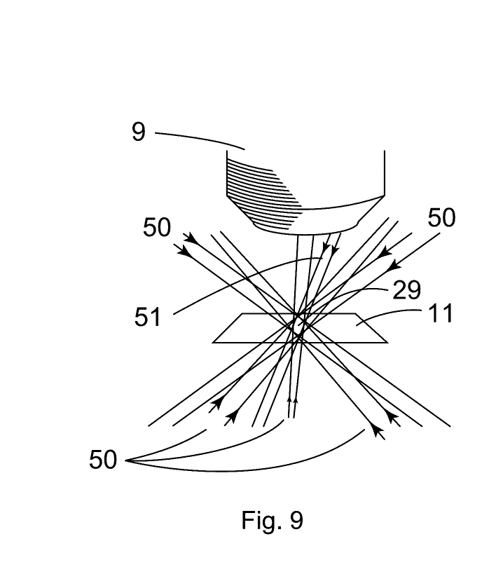

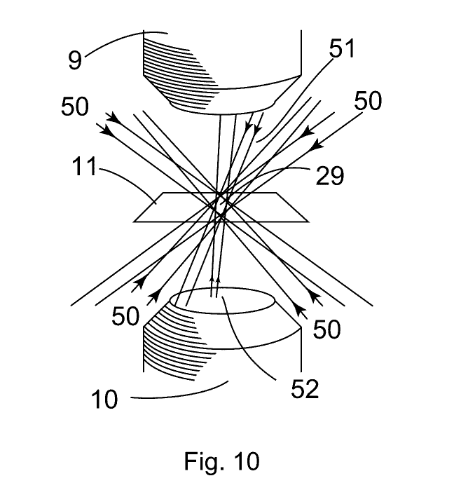

To minimize the incidence of ghost images, illumination patterns with larger spacing along Z (but with equally-compact bright peaks in X, Y, and Z) are desirable. Illumination beams from outside of the objective apertures are helpful in constructing such patterns, and these beams, illustrated in FIG. 9 and FIG. 10 comprise embodiments of the invention which make use of beams from both inside the objective aperture 51 and 52 as well as outside the aperture 50. The following tables disclose beam geometries which provide compact illumination points in a crystalline pattern according to the present invention. These arrangements comprise beams emerging from outside of the objective apertures. They greatly reduce ghost images and also enable the use of long working distance objective lenses (with perhaps relatively lower NA) that further accommodate relatively thicker specimen volumes.

### Beam Geometry 3

| \vec{k}ₓ | \vec{k}_{y} | \vec{k}_{z} | \hat{p}ₓ | \hat{p}_{y} | \hat{p}_{z} | Source |
|---|---|---|---|---|---|---|
| 14.8300 | 0 | −8.5621 | 0.2236 | 0.8944 | 0.3873 | Outside |
| −14.8300 | 0 | −8.5621 | 0.2236 | 0.8944 | −0.3873 | Outside |
| 0 | 14.8300 | 8.5621 | 0.8944 | 0.2236 | −0.3873 | Outside |
| 0 | −14.8300 | 8.5621 | 0.8944 | 0.2236 | 0.3873 | Outside |
| 0 | 0 | 17.1243 | 0.7071 | 0.7071 | 0 | Objec- |
| | | | | | | tive 1 |
| 0 | 0 | −17.1243 | 0.7071 | 0.7071 | 0 | Objec- |
| | | | | | | tive 2 |

### Beam Geometry 4

| \vec{k}ₓ | \vec{k}_{y} | \vec{k}_{z} | \hat{p}ₓ | \hat{p}_{y} | \hat{p}_{z} | Source |
|---|---|---|---|---|---|---|
| 16.1449 | 0 | −5.7081 | 0.1054 | 0.9487 | 0.2981 | Outside |
| −16.1449 | 0 | −5.7081 | 0.1054 | 0.9487 | −0.2981 | Outside |
| 0 | 16.1449 | 5.7081 | 0.9487 | 0.1054 | −0.2981 | Outside |
| 0 | −16.1449 | 5.7081 | 0.9487 | 0.1054 | 0.2981 | Outside |
| 0 | 0 | 17.1243 | 0.7071 | 0.7071 | 0 | Objec- |
| | | | | | | tive 1 |
| 0 | 0 | −17.1243 | 0.7071 | 0.7071 | 0 | Objec- |
| | | | | | | tive 2 |

### Beam Geometry 5

| \vec{k}ₓ | \vec{k}_{y} | \vec{k}_{z} | \hat{p}ₓ | \hat{p}_{y} | \hat{p}_{z} | Source |
|---|---|---|---|---|---|---|
| 14.8300 | 0 | −8.5621 | 0.2236 | 0.8944 | 0.3873 | Outside |
| −14.8300 | 0 | −8.5621 | 0.2236 | 0.8944 | −0.3873 | Outside |
| 0 | 14.8300 | 8.5621 | 0.8944 | 0.2236 | −0.3873 | Outside |
| 0 | −14.8300 | 8.5621 | 0.8944 | 0.2236 | 0.3873 | Outside |
| 14.8300 | 0 | 8.5621 | 0.2236 | 0.8944 | −0.3873 | Outside |
| −14.8300 | 0 | 8.5621 | 0.2236 | 0.8944 | 0.3873 | Outside |
| 0 | 14.8300 | −8.5621 | 0.8944 | 0.2236 | 0.3873 | Outside |
| 0 | −14.8300 | −8.5621 | 0.8944 | 0.2236 | −0.3873 | Outside |
| 0 | 0 | 17.1243 | 0.7071 | 0.7071 | 0 | Objec- |
| | | | | | | tive 1 |
| 0 | 0 | −17.1243 | 0.7071 | 0.7071 | 0 | Objec- |
| | | | | | | tive 2 |

### Beam Geometry 6

| \vec{k}ₓ | \vec{k}_{y} | \vec{k}_{z} | \hat{p}ₓ | \hat{p}_{y} | \hat{p}_{z} | Source |
|---|---|---|---|---|---|---|
| 16.1449 | 0 | −5.7081 | 0.1054 | 0.9487 | 0.2981 | Outside |
| −16.1449 | 0 | −5.7081 | 0.1054 | 0.9487 | −0.2981 | Outside |
| 0 | 16.1449 | 5.7081 | 0.9487 | 0.1054 | −0.2981 | Outside |
| 0 | −16.1449 | 5.7081 | 0.9487 | 0.1054 | 0.2981 | Outside |
| 16.1449 | 0 | 5.7081 | 0.1054 | 0.9487 | −0.2981 | Outside |
| −16.1449 | 0 | 5.7081 | 0.1054 | 0.9487 | 0.2981 | Outside |
| 0 | 16.1449 | −5.7081 | 0.9487 | 0.1054 | 0.2981 | Outside |
| 0 | −16.1449 | −5.7081 | 0.9487 | 0.1054 | −0.2981 | Outside |
| 0 | 0 | 17.1243 | 0.7071 | 0.7071 | 0 | Objec- |
| | | | | | | tive 1 |
| 0 | 0 | −17.1243 | 0.7071 | 0.7071 | 0 | Objec- |
| | | | | | | tive 2 |

Additional alternative designs and assemblies are within the scope of this disclosure and although several are described they are not intended to define the scope of the invention or to be otherwise limiting. For example, while the discussion above focuses on substantially transparent (naturally so, thin-cut, or clarified) tissue specimens, in fluorescence, with visible light radiation, the present invention can apply in a range of specimen types, contrast modes (including reflection, phase, polarization, and others), and radiation spectra.

We claim:

1. A system for imaging a specimen comprising:
a plurality of radiation beams
directing means to direct said plurality of radiation beams in a beam geometry designed to produce a crystalline pattern of radiation intensity in a volume of interference
positioning means to position said specimen such that at least a portion of the specimen coincides with said volume of interference
imaging means to image radiation emitted from said specimen in response to said pattern

2. The system of claim 1 wherein said pattern is substantially stationary.

3. The system of claim 1 further comprising a beam modulator constructed to modulate at least one of said plurality of radiation beams to control said pattern.

4. The system of claim 1 wherein said emitted radiation is fluorescence.

5. The system of claim 1 wherein said imaging means comprises a first camera focused on a first plane within said pattern.

6. The system of claim 5 wherein said imaging means further comprises a second camera focused on a second plane within said pattern.

7. The system of claim 1 wherein said imaging means further comprises at least one objective lens.

8. The system of claim 7 wherein at least one of said plurality of beams emerges from said at least one objective lens.

9. The system of claim 1 wherein said pattern comprises a plurality of intensity peaks.

10. The system of claim 9 wherein said imaging means comprises a collection point spread function substantially aligned with one of said peaks.

11. A method for imaging a specimen comprising:
providing a plurality of radiation beams
directing said plurality of beams in a beam geometry designed to produce a crystalline pattern of radiation intensity in a volume of interference
positioning said specimen such that at least a portion of the specimen coincides with said volume of interference
imaging radiation emitted from said specimen in response to said pattern

12. The method of claim 11 wherein said positioning further comprises scanning said specimen relative to said volume.

13. The method of claim 12 wherein said imaging further comprises recording a raw data set of emitted radiation intensity at a plurality of positions during said scanning.

14. The method of claim 13 further comprising estimating specimen brightness from said raw data set by numerical deconvolution of a type chosen from the list including linear, nonlinear, iterative, or a combination of these.

15. The method of claim 11 wherein said directing further comprises controlling beam parameters chosen from the list including angle, phase, intensity, polarization, wavelength.

16. The method of claim 15 wherein said controlling controls said pattern to be substantially stationary.

17. The method of claim 15 wherein said controlling controls said pattern to change over time.
